(19) United States
(12) Patent Application Publication
(10) Pub. No.: US 2008/0206272 A1
(43) Pub. Date: Aug. 28, 2008

(54) Method for Repelling Pests with an Insect Repellent Composition Based on Garlic

(75) Inventors: Willem Govert Van Garderen, Almere (NL); Gerard Theodorus De Zeeuw, Austerlitz (NL); Jan Copier, Ede (NL)

Correspondence Address: FOLEY AND LARDNER LLP;SUITE 500, 3000 K STREET NW, WASHINGTON, DC, 20007, US

(73) Assignee: Copier Groenadvies B.V.

(21) Appl. No.: 11/721,960

(22) PCT Filed: Dec. 15, 2005
(86) PCT No.: PCT/NL05/50075

§ 371 Date: Nov. 26, 2007

(30) Foreign Application Priority Data
Dec. 15, 2004 (NL) 1027792
Jun. 16, 2005 (NL) 1029267

(51) Int. Cl. A01N 65/00; A01P 17/00

(52) U.S. Cl. 424/195.17

(57) ABSTRACT

The Invention relates to a method for repelling pests, in particular insects, larvae, spiders or aphids, from a plant, in particular from a tree or bush, wherein the method comprises making a hole down to the root zone of a plant and putting a natural insect repellent composition that contains at least garlic and/or an extract thereof in this hole. As a result of the method of administration according to the invention a homogeneous distribution is achieved by take up of the composition via the roots. In addition, the invention also relates to an insect repellent composition with an enhanced activity by combining the garlic with one or more of seaweed extract, soya oil, aloe vera, nut leaf extract, parsley extract, African Marigold extract, Nepeta extract and Urtica extract as a result of which a fungicidal and/or antifungal action, improved take up and/or improved vitality of the plant is achieved.

### BACKGROUND TO THE INVENTION

The present invention relates to a method for repelling pests, preferably insects, larvae, aphids, spiders, slugs and the like, from a plant (vegetation), preferably from trees, shrubs and bushes and in particular from trees, by administration of an insect repellent composition based on garlic.

It is known in the state of the art that garlic (Allium sativum Linn) and extracts thereof have an antibacterial and fungicidal action. More recently it has been found that garlic can also be used as insect repellent. For instance, it is described in U.S. Pat. No. 5,733,552 how areas can be made “gnat-free” by spraying a mixture of garlic extract and water on these locations.

A natural pesticide based on garlic oil or garlic extract and an essential oil is also described in EP-A 945 066 for combating, for example, mildew. In this case the treatment likewise comprises spraying the composition on the plants. A similar substance is described in U.S. Pat. No. 5,429,817, JP A 2003192516 and CN A 1170504.

A liquid fertiliser with insect repellent properties is described in Japanese Patent Application 62270485. The liquid fertiliser contains inter alia garlic and African Marigold.

In Japanese Patent Application 58067169 a juice is described where a garlic extract is mixed with juice that has been pressed from fruit, vegetables, vegetable material, seaweed and the like.

Such methods have the disadvantage that the duration of this single exposure to insecticides is limited, certainly in climates with a great deal of precipitation and wind. In addition, spraying seldom leads to a homogeneous distribution over the plants and the access to higher plants is often difficult. Moreover, with such a treatment much of the sprayed liquid is lost by evaporation, etc. Because the absorption of insecticides via the foliage is very limited, the effects on insects, larvae and aphids that are found in other places, such as in the bark of a tree, will be reduced.

### AIM OF THE INVENTION

One aim of the invention is to change the smell and taste of a plant, preferably a tree, shrub, bush or grass and in particular of trees and by this means to make these uninviting for insects, aphids, larvae, spiders and other pests such as slugs, by providing a method for administering an insect repellent composition based on garlic with a biologically and ecologically sound action, wherein the active constituents are dosed, evenly distributed and easily administered and care is taken that there is no odour nuisance for the environment.

A further aim of the invention is to improve the vitality of the plant, in particular a tree, shrub, bush or grass, at the same time.

### DESCRIPTION OF THE INVENTION

The invention relates to a method for repelling pests, preferably insects, larvae, spiders or aphids, from a plant, in particular from a tree, shrub, bush or grass and in particular from a tree, wherein the plant is treated with a natural insect repellent composition that [lacuna] at least garlic and/or an extract thereof and seaweed and/or an extract thereof.

Preferably the method comprises making a hole down to the root zone of the plant and putting the natural insect repellent composition in this hole.

“Natural” insect repellent composition refers to the fact that this consists of principally biologically available constituents so as thereby not to contaminate the plant and the ground.

According to the invention a plant is understood to be the collection of trees, shrubs and bushes, including grasses. The method according to the invention is in particular suitable for repelling insects, spiders, larvae or aphids from a plant, in particular from a tree or bush, more particularly from a tree.

According to the invention pests are understood to be especially insects, larvae, spiders or aphids, but also slugs can be included here.

The insect repellent composition according to the invention is based on garlic, that is to say that this insect repellent composition contains at least garlic and/or an extract thereof. Garlic extract is in this case defined as any liquid that can be extracted from a garlic clove, including garlic oil and water. Garlic juice, such as prepared by pressing garlic cloves, is also suitable as constituent in the insect repellent composition according to the invention. In the rest of this description these variants are referred to by the inclusive term “garlic”.

It has been found that this administration form leads to improved distribution of an insect repellent composition over the entire plant, because the insect repellent composition is further transported through the plant in the xylem of the plant after absorption via the roots and is distributed over the whole plant, including root, stem, branches and leaves. “Xylem” refers to the vascular system that is responsible for the transport of water, minerals, nutrients and other especially inorganic substances through the plant. In the context of the invention the xylem consists of not only the wood vessels in the stem or stalk, but also all cells that contribute to the water transport through the plant, but also the water channels such as those that start in the root hairs and end in the leaves and needles. By making the insect repellent composition available via the root hairs, much less material is lost than via spraying of the foliage of the plant from the outside.

As a result of this more efficient use a lower dosage of the active constituents of the insect repellent composition can suffice and this has the additional advantage that possible (odour) nuisance for the environment by the garlic is reduced. The plants that take up this insect repellent composition in their sap do not start to smell. Moreover, a more long-lasting effect can be achieved as a result of this more efficient use.

According to the invention at least one hole is made in the ground in which the plant is rooted and specifically within such a distance from the plant that this hole is situated in the “root zone”. The root zone is the ground layer in which the living roots are found, for practical reasons considered to be the layer in which the great majority of the roots are located. The root zone therefore comprises the entire surface of the surroundings of the plant where roots grow. In specific embodiments it is preferable that the holes are made in the “root hair zone”, that is to say the part of the root zone in which the root hairs occur. This root hair zone is located within the root zone on the outside. The take up of moisture and food is highest in this location.

The average person skilled in the art will be able to estimate simply on the basis of the bulk of the plant visible above the ground how far and how deep the roots reach. In this respect it is preferable that at least one hole is made within the so-called crown projection, that is to say the margin of the crown, the bulk of the branches and the foliage, projected on the ground, preferably at least 1 metre within the margin of the crown projection. More preferentially at least one hole will be made at a distance of less than 1.5 metre, in particular within 1 metre of the outside of the trunk. The hole in the ground is preferably less than 1.5 metre, preferably between 20 cm and 1 metre deep in the ground.

Preferably several holes are made in the root zone, at least one per square metre of the crown projection, preferably in a uniform distribution around the trunk. The insect repellent composition—and consequently the garlic—can then be administered in a uniform manner. The necessary number of holes is furthermore dependent on the desired dosage of the garlic and will be described in more detail below. This hole is preferably a pop hole, that is to say a hole that is made with air pressure or, if so desired, finished off with air pressure after making the hole. By “popping” the ground is aerated, airways are created, in particular in essentially the horizontal direction, in the root zone and disruptive layers are penetrated. In addition, oxygen is administered in this manner. This can be advantageous in cases where gas exchange in the ground is hindered by compaction of the ground as a result of, for example, vibrations due to traffic.

In a preferred embodiment the insect repellent composition combined with a thickener is put in the hole. This is done, for example, by means of injection at high pressure. The thickener ensures that the composition has viscous properties and does not seep away into the ground rapidly. In this way retarded dosing of the composition over at least one and a half weeks is achieved.

The insect repellent composition is preferably put in the hole in a container. The insect repellent composition can in this case be applied before or after installing the container in the ground. However, it is preferable to place the container in the ground first and put the insect repellent composition in the container afterwards. The hole has a diameter such that the container fits therein and is preferably—within the root zone—of such a depth than (sic) the container can be concealed under the surface around the plant.

The container can be closed, has preferably a removable cap and the container is provided with at least one perforation that makes controlled transport of the insect repellent composition to the outside possible and in this way ensures sustained administration of the insect repellent composition, preferably spread over 1 to 4 weeks, more preferentially at least one and a half weeks. The perforation is of such a size that the garlic is released only by the suction of the surrounding soil particles. Consequently, it is preferable that the perforation has a size of 0.5-1 mm.

Preferably several, more preferentially between 3 and 10 perforations are made so as to reduce the risk of blockage. These several perforations can be situated on one or several sides of the container, but at least one perforation will be located in the bottom so as to prevent material being left on the base of the container. The perforations are preferably uniformly distributed over the height of the container. By using closed containers provided with one or more small perforations retarded dosage of the insect repellent composition is achieved and flushing out downwards, away from the root zone, is prevented prevented (sic). If necessary the speed of release can be increased by making additional perforations in a container that already has one or more perforations. The speed of release could also be reduced by sealing off, for example with tape, one or more perforations.

The container is preferably made of a plastic. The container can be in the form of a tube, in particular a tube with a length between 20 and 80 cm and a diameter between 5 and 100 mm. The container has preferably a capacity of 4 ml-6.3 l, more preferentially 0.25-3.0 litre.

In another preferred embodiment the container is a drainage hose. This drainage hose is placed in the hole such that this is located essentially horizontally in the root zone. The hole is then a trench, preferably a ring-shaped trench around the trunk, preferably with a depth of 20 cm-1 m within the root hair zone. The drainage hose can be closed at both ends with a removable cap, but at at least one end, so that there is a filling point. The other end can then be closed permanently. Such a drainage hose has the advantage that this can easily be spread over a large area, for example as an unbroken piece around a plant, or stretched out along a row of plants. Thus a large area can be covered using a drainage hose and there is an added advantage that the entire area can be provided with the composition via one filling point. This can in particular be advantageous if administration has to be carried out several times, so the drainage hose can be reused. In such an embodiment the drainage hose has more perforations, depending on the length of the hose and the area that this covers. Consequently, in the description and appended claims, the term “container” also includes a drainage hose.

After putting the insect repellent composition in the hole in the root zone the hole is closed. In this case it is preferable to cover the hole again with the original material, such as ground level material or paving.

The position of the container can be marked in order to find the location thereof easily, for example in order to be able to remove the container later. However, the container can in this way also be re-used in order thus to save the costs of the container and the work associated with installation thereof.

Preferably, before putting the insect repellent composition in the hole it is mixed with water in a mass ratio that lies between 1:5 and 1:200, preferably between 1:40 and 1:110. In this case it is possible that the insect repellent composition is stored in aqueous medium, but it is more preferable to mix the insect repellent composition with water on site. In the case where a container is used, the insect repellent composition can be mixed with water just before the container is placed in the hole, but also after the container is already in the hole.

Furthermore, it is possible that a binder is added to the mixture of water and insect repellent composition. If the insect repellent composition is put into the hole directly—without containers—a binder has to be added. This binder imparts a viscous character to the aqueous insect repellent composition and by this means retards the dosing of the insect repellent composition to the surroundings. By this means it is possible to keep the insect repellent composition active in the ground for a longer time. The binder must be a biological thickener, preferably on the basis of starch. Preferably the mass ratio of the solid constituents of the insect repellent composition and the binder is between 3:1 and 1:3.

In order to achieve the insect repellent effect by administration in the root zone according to the invention, it has been found that the garlic has to be administered in an amount, in the case of a tree, between 40 and 160 milligram per centimetre trunk thickness, preferably 60-140 mg per centimetre trunk thickness, and in the case of a bush, between 4 and 20 mg per centimetre bush breadth, preferably 10-18 mg per centimetre bush breadth.

After administration the active substances according to the invention are released into the ground, they are taken up via the root and transported to the other parts of the plant. In this way the smell and taste of these substances are encountered in the trunk, branches and leaves with which pests make contact. As a result of this the pests are repelled.

The invention also relates to a natural insect repellent composition for repelling pests, in particular insects, larvae, spiders and aphids, from a plant, in particular from a tree, shrub, bush or grass, more particularly from a tree, where the insect repellent composition contains at least garlic and/or an extract thereof. This insect repellent composition is suitable for the administration according to the invention.

It is preferable that the insect repellent composition furthermore contains seaweed and/or seaweed extract. Such a composition possesses not only an increased insect repellent activity of the garlic, but the seaweed extract has additionally a fungicidal action and retards the development of harmful soil-borne fungi. The seaweed also enhances the vitality of the plant. Preferably, on dry weight basis, the composition contains 10-60% (m/m), preferably 20-55% (m/m) garlic and/or an extract thereof and 2-20% (m/m) seaweed and/or seaweed extract.

More preferentially the insect repellent composition additionally contains soya oil. Besides an additional repellent action this also has a transport function and in this way ensures improved take up of the composition by the plant. The quantity thereof is preferably 1-30% (m/m), preferably 2-20% (m/m), on dry weight basis.

In particular the insect repellent composition according to the invention additionally contains aloe vera, as a result of which the composition further improves the vitality of the plant, preferably in an amount of 1-10% (m/m), on dry weight basis.

The insect repellent composition according to the invention can additionally contain one or more of nut leaf extract, parsley extract, African Marigold extract, Nepeta extract and Urtica extract. It has been found that all these extracts have an insect repellent, in particular an aphid repellent, action, as a result of which they enhance the insect repellent action of garlic in the composition. Consequently, most preferentially all the listed constituents are present in the composition together. Preferably the insect repellent composition according to the invention contains these constituents, if present, in an amount of:
1-10% (m/m) nut leaf extract;
1-20% (m/m) parsley extract;
1-10% (m/m) African Marigold extract;
1-10% (m/m) Nepeta extract; and
2-20% (m/m) Urtica extract, on dry weight basis.

Of course a natural binder can be added to increase the viscosity and consequently to retard the dosing. This binder is preferably on the basis of starch. The preferred ratio of the binder with respect to the other solid constituents lies between 3:1 and 1:3.

It has been found that an insecticide with such a composition in a low dosage is very effective. The insect repellent action of the odour and taste substances from the garlic is enhanced, as a result of which relatively less of this odorous substance is necessary. Besides an insect repellent effect this insect repellent composition also has a fungicidal and/or antifungal action and this also affords better vitality of the plant.

The insect repellent composition according to the invention is particularly suitable for treating trees, plants, shrubs or bushes so as to repel therefrom insects, aphids, spiders, caterpillars, larvae, and other such pests, such as slugs. In this context repel is also understood to include a preventive treatment in order to prevent a plague of such pests or fungus growth and/or to improve the vitality of the plant. The insect repellent composition can be successfully employed in the for (sic) combating/prevention of disease and/or disorders such as plant louse, Dutch elm disease, caterpillar of the oak procession moth, leaf miner, mildew and honeydew, etc. Preferably the insect repellent composition is administered at an early stage after the diagnosis and particularly in the spring or early summer, because specifically in this period the sap in the plants starts to flow. The take up in the moisture from the ground is then optimum.

The insect repellent composition according to the invention can be in the form of a tablet, capsule or granulate, but can also be available in the form of an aqueous solution, where the total amount of solid constituents is between 10-100 gram per litre water. If the composition is in the form of a capsule, tablet or granulate it is preferable that the ratio of the composition and water in the mixture is between 1:5 and 1:50, preferably less (sic) 1:5-1:20.

For the preparation of capsules it is, however, preferable that the solid constituents are taken up in a vegetable oil, preferably soya oil, and that the capsule wall consists of gelatine. The capsule can be a hard or a soft capsule.

For the preparation of a granulate preferably a particulate filler such as vermiculite is used.

For administration according to the invention the insect repellent composition is diluted with water to a dosage that is effective according to the aim of the invention, preferably a ratio of the insect repellent composition, optionally provided as aqueous mixture, mixed with water in a ratio (sic) that lies between 1:5 and 1:200, preferably between 1:10 and 1:100.

Although the insect repellent composition according to the invention preferably is administered by take up via the root zone, this can also be taken up by spraying via the leaves. This is especially possible as a result of the enhanced activity of the composition, in particular if the composition in addition to garlic also contains seaweed extract and aloe vera, more particularly also soya oil, and most preferentially also parsley extract, nut leaf extract, African Marigold extract, Nepeta extract and Urtica extract.

As a result of the enhanced insect repellent activity the composition can be sprayed at lower garlic concentrations than usual in the state of the art, as a result of which less odour nuisance is caused and the efficacy is increased. The composition following (sic) invention is then preferably diluted with water to a ratio of 1:80-1:200, preferably less than 1:110.

The invention also relates to a combination of a container with an insect repellent composition according to the invention, wherein the container can be closed and has at least one perforation. Furthermore, the container can have the characteristics as described above.

The present invention relates to a method for treating a piece of ground covered with grass. The present invention relates more particularly to the treatment of a piece of ground covered with grass that has been attacked by harmful pests, in particular one or more harmful insects. The present invention also relates to the preventive treatment of a piece of ground covered in grass for prevention of attack by harmful pests, in particular one or more harmful insects.

According to the present application the term “insects” includes not only the adult organisms, but also other forms such as larvae, pupae and the like.

Pieces of ground that are covered in grass, for example a lawn, sports field, playing field, meadow, airfield or the like, in particular sports fields, can be attacked by harmful insects. As a result of this the grass grows poorly and the grass mat on the piece of ground is weak, particularly when this is used intensively. The result of this is that the piece of ground becomes unusable for the intended purpose within a short time. A well-known example is a football pitch.

In the state of the art there are no known naturally based substances with which such harmful insects can be combined. In addition, in the state of the art there are no known substances with which pieces of ground covered in grass can be treated in an environmentally friendly manner in order to prevent attack by harmful insects.

Surprisingly it has now been found that the insect repellent composition according to the present invention is exceedingly suitable for the treatment of a piece of ground covered in grass that has been attacked by one or more harmful insects or for the treatment of a piece of ground covered in grass for preventing attack by harmful insects.

Consequently, the present invention also relates to a method for the treatment of a piece of ground covered in grass, wherein:
(a) an insect repellent composition that contains at least garlic and/or an extract thereof and seaweed and/or an extract thereof is applied to the piece of ground covered in grass; and
(b) the piece of ground covered in grass is watered.

According to the present invention voracious insects are concerned in particular and particularly the May beetle (Melolontha melolontha), the summer chafer (Amphimallon solstitialis), the garden chafer (Phyllopertha horticola), the leatherjacket i.e. meadow cranefly (Tipula paludosa) and the blossom fly (Dilophus febrilis).

For preventive treatment preferably about 0.5 to about 5 litre of the insect repellent composition is used per 500 m² ground covered in grass, more preferentially about 0.7 to about 2.5 litre per 500 m².

For curative treatment about 0.7 to about 7.5 litre of the insect repellent composition is used per 500 m² ground covered in grass, more preferentially about 1.0 to about 5.0 litre per 500 m².

By use of the insect repellent composition both the ground as well as the vegetation takes on the aroma of the substance. With the complete composition of the insect repellent composition there is also an improvement in the vitality so that root development becomes optimum. By administration, insets will no longer eat the root of the plants and the parts of the plants. As a result of this, larvae will suffer a premature death from hunger and therefore not break out of the pupa and reach the adult stage. Flying and crawling insects will also no longer eat below ground and/or above ground parts of plants and will avoid the area.

Preferably the insect repellent composition will be applied to the ground covered in grass by means of watering or spraying. In the state of the art various devices are known for applying fertiliser to the ground by means of spraying and/or injecting. By way of illustration reference is made to NL 1012650, U.S. Pat. No. 5,590,611, U.S. Pat. No. 4,934,287. Consequently, according to the invention it is preferable that the insect repellent composition is applied to the ground covered in grass by means of spraying with the aid of a spraying or injection device that, for example, can be mounted on a suitable vehicle such as a tractor.

More preferentially the composition is applied by means of injection, in particular with the aid of an injecting machine for injecting liquid fertiliser compositions. Such a device is, for example, described in EP A 1 086 617. Such a device is found to be very suitable for introducing or injecting a liquid, for example a liquid fertiliser or the insect repellent composition according to the present invention, in the ground. Such a device comprises a supply part that can be mounted on a suitable vehicle such as a tractor and to which a liquid, for example from a tank, can be fed, a dispensing part that can turn with respect to the supply part and from which tubes or hollow pins extend, where the ends of the tubes or hollow pins can penetrate the ground and discharge the liquid there. The device can obviously consist of one or more such combinations of supply part and dispensing part and the working width and configuration can be adapted as desired. For instance the liquid can be injected under pressure. The advantage of such a device is that no evaporation or volatilisation of the insect repellent composition occurs.

The insect repellent composition is also injected in the immediate vicinity of the roots so that it can be taken up easily. Moreover the dosage of the insect repellent composition can easily be adapted to the requirements and this can be regulated very accurately. A very suitable device is marketed by the firm Duport B.V., Dedemsvaart, The Netherlands, under the name Duport Liquiliser.

### EXAMPLES

### Example 1a

An insect repellent composition for repelling insects, spiders, aphids and larvae from trees, plants, shrubs or bushes, which contains:

9 g garlic;

2 g soya oil;

1 g parsley extract;

2 g seaweed extract;

1 g nut leaf extract;

1 g aloe vera;

1 g African Marigold extract;

1 g Nepeta extract; and

2 g Urtica extract,

with a total of 20 gram of constituents and wherein the constituents were previously extracted in 100 ml ethanol by means of preheating and then mixed with hand-hot tap water.

### Example 1b

The insect repellent composition according to Example 1 was made up to 1 litre with water.

### Example 1c

Subsequently 15 gram binder on the basis of starch was added to 1 litre mixture as prepared in Example 1b.

### Example 2

Leaf miner was ascertained on a chestnut tree with a crown projection of 10 m². To treat this, 10 holes were made in the ground in the crown projection. These holes were dug to a depth of 60 cm and were located in a circle evenly distributed around the trunk, each at a distance of about 1 m from the tree. A tube with a capacity of approx. 2 litre and with 4 evenly distributed perforations on the long side and 1 perforation in the bottom was put into each hole. Subsequently 1 part (by mass) of the composition according to Example 1b was mixed with 50 parts water and this was then administered into the tubes. The tubes were closed with a lid. The ground was covered over with the original soil. After two weeks following covering spot checks were made to see if solution had been released.

### Example 3

As Example 2, but instead of applying the composition in containers, after digging holes around the tree these holes were filled with a mixture of water and the thickened mixture according to Example 1c in a mass ratio of 50:1, introduced by injection at a pressure of about 50 bar. The holes were then covered and spot checks were made after two weeks.

### Example 4

During the planting of an oak tree with a trunk diameter of 5 cm and a root zone diameter of approx. 1 m², 10 litre insect repellent composition with thickener as prepared according to Example 1c mixed with water in a mass ratio of 1:50 (1 part by mass thickened composition, 50 parts water) were administered next to the root ball. Afterwards the plant hole was filled in. As a result of this the substance could be available to the tree directly at the start of growth. Metallic oak boring beetle was prevented by this means.

### Example 5

Chestnut disease was detected in a chestnut tree with a crown projection of 100 m². To treat this, a pop hole was made with air pressure to a depth of 80 cm. By means of this popping (=soil aeration) airways were created in the root zone and disruptive layers were penetrated. Oxygen was also administered in this way. In addition, the insect repellent composition according to Example 1c was mixed with water in a mass ratio of 1:50. This mixture was introduced into the pop holes by means of injection at a pressure of approx. 50 bar.

1-22. (canceled)

23. A method for repelling pests from a plant, the method comprising treating the plant with an insect repellent composition comprising (a) garlic and/or an extract of garlic and (b) seaweed and/or an extract of seaweed.

24. The method according to claim 23, wherein the insect repellent composition comprises, on dry weight basis, (a) 10-60% (m/m) garlic and/or an extract of garlic and (b) 2-20% (m/m) seaweed and/or an extract of seaweed.

25. The method according to claim 23, wherein the treating comprises administering the insect repellent composition into a hole leading to the root zone of the plant.

26. The method according to claim 23, wherein the pests comprise insects, larvae, spiders or aphids.

27. The method according to claim 23, wherein the plant is a tree, shrub, bush or grass.

28. The method according to claim 23, wherein the insect repellent composition further comprises soya oil.

29. The method according to claim 23, wherein the insect repellent composition further comprises aloe vera.

30. The method according to claim 25, wherein the insect repellent composition is combined with a binder prior to administration.

31. The method according to claim 23, wherein the insect repellent composition is administered in a container.

32. The method according to claim 31, wherein the container is comprises at least one perforation.

33. The method according to claim 31, wherein the container is a drainage hose.

34. The method according to claim 25, wherein the hole is closed after administration of the insect repellent composition.

35. The method according to claim 25, wherein insect repellent composition is mixed with water in a mass ratio that between 1:5 and 1:200 prior to administration.

36. The method according to claim 27, wherein the tree is treated with between 40 and 160 mg garlic and/or extract of garlic per centimeter trunk thickness

37. The method according to claim 27, wherein the bush is treated with between 4 and 20 mg garlic and/or extract of garlic per centimeter bush breadth.

38. The method according claim 23 further comprising nut leaf extract, parsley extract, African Marigold extract, Nepeta extract, Urtica extract, or combinations thereof.

39. The method according to claim 23, wherein the insect repellent composition comprises:
10-60% (m/m) garlic,
2-20% (m/m) seaweed extract;
and further comprises:
1-30% (m/m) soya oil;
1-10% (m/m) aloe vera;
1-10% (m/m) nut leaf extract;
1-20% (m/m) parsley extract;
1-10% (m/m) African Marigold extract;
1-10% (m/m) Nepeta extract; and
2-20% (m/m) Urtica extract,
on dry weight basis.

40. The method according claim 23, wherein the insect repellent composition is in the form of a tablet, capsule or granulate.

41. The method according to claim 23, wherein the insect repellent composition is in the form of an aqueous solution, wherein the total amount of constituents is between 10-100 gram per liter water.

42. The method according to claim 27, wherein the plant is grass.

43. The method according to claim 42, comprising applying the insect repellent composition to the grass and watering the grass.

44. A container comprising an insect repellent composition comprising a garlic and/or an extract thereof and seaweed and/or an extract thereof, wherein the container can be closed and has at least one perforation.

45. The container according to claim 44 in which the container is a tablet, capsule or granulate.

46. Aqueous solution comprising an insect repellent composition comprising component (a) garlic and/or an extract thereof and component (b) seaweed and/or an extract thereof, wherein the total amount of components (a) and (b) is between 10-100 gram per liter water.
